(19) United States
(12) Patent Application Publication
(10) Pub. No.: US 2026/0295890 A1
(43) Pub. Date: Oct. 1, 2026

(54) CHAINSAW

(71) Applicant: Makita Corporation, Anjo-shi (JP)

(72) Inventors: Shotaro KOMORI, Anjo-shi (JP); Tomoyuki KUTSUNA, Anjo-shi (JP)

(73) Assignee: Makita Corporation, Anjo-shi (JP)

(21) Appl. No.: 19/633,186

(22) Filed: Mar. 30, 2026

(30) Foreign Application Priority Data
Apr. 1, 2025 (JP) 2025-060736

(51) Int. Cl. B27B 17/02; B27B 17/08; B27B 17/00; B27B 17/14

(52) U.S. Cl. CPC B27B 17/02; B27B 17/08; B27B 17/0008; B27B 17/14

(57) ABSTRACT

A chain-oil-free type chainsaw may have: a guide bar; a sprocket; a saw chain looped around the guide bar and the sprocket; an electric motor which rotates the sprocket; a housing accommodating the motor; and a sprocket cover covering the sprocket, in which a chain passage may be formed by the sprocket, the housing, and the cover, in the chain passage at least one of the housing and the cover has a facing surface facing the sprocket, and, when the chainsaw is viewed from a lateral side, an inclination angle of the facing surface relative to a front-rear direction at a first reference position may be 90 degrees or more.

### CROSS REFERENCE TO RELATED APPLICATIONS

This application claims priority to Japanese Patent Application No. 2025-060736 filed on Apr. 1, 2025. The entire content of the priority application is incorporated herein by reference.

### TECHNICAL FIELD

The art disclosed herein relates to a chainsaw.

### BACKGROUND ART

U.S. Patent Application Publication No. 2022/0111551 describes a chainsaw. The chainsaw includes a guide bar disposed such that its center axis extends along a front-rear direction, a sprocket disposed rearward of the guide bar such that its rotation axis extends along a left-right direction, a saw chain looped around the guide bar and the sprocket, an electric motor configured to rotate the sprocket about the rotation axis, a housing that accommodates the electric motor, and a sprocket cover that covers the sprocket. The saw chain travels such that, along with rotation of the sprocket, the saw chain moves from below the guide bar to below the sprocket, then moves from below the sprocket to move on a rear side of the sprocket to above the sprocket, then moves from above the sprocket to above the guide bar, and then moves from above the guide bar to move on a front side of the guide bar to below the guide bar. A chain passage through which the saw chain passes is formed by the sprocket, the housing, and the sprocket cover. In the chain passage, the housing has a facing surface that faces the sprocket in a radial direction of the sprocket. When the chainsaw is viewed from a lateral side, a straight line passing through a center position of the saw chain at a location where the saw chain separates from the guide bar below the guide bar and through the center position of the saw chain at a location where the saw chain engages the sprocket below the sprocket is defined as a first reference line, a position at which the first reference line intersects the facing surface is defined as a first reference position, and an inclination angle of the facing surface with respect to the front-rear direction at the first reference position is less than 90 degrees.

### SUMMARY

In a so-called chain-oil-free type chainsaw, which can conduct cutting operations without lubricating oil applied between the saw chain and the guide bar, cutting debris tends to clog the chain passage. This specification provides art that allows the chainsaw to suppress cutting debris from clogging a chain passage in a chain-oil-free chainsaw.

A chain-oil-free type chainsaw disclosed herein may comprise: a guide bar disposed such that a center axis thereof extends along a front-rear direction; a sprocket disposed rearward of the guide bar such that a rotation axis thereof extends along a left-right direction; a saw chain looped around the guide bar and the sprocket; an electric motor configured to rotate the sprocket about the rotation axis; a housing that accommodates the electric motor; and a sprocket cover that covers the sprocket, wherein the saw chain may travel such that, along with rotation of the sprocket, the saw chain moves from below the guide bar to below the sprocket, then moves from below the sprocket to move on a rear side of the sprocket to above the sprocket, then moves from above the sprocket to above the guide bar, and then moves from above the guide bar to move on a front side of the guide bar to below the guide bar, a chain passage through which the saw chain passes may be formed by the sprocket, the housing, and the sprocket cover, in the chain passage, at least one of the housing and the sprocket cover may have a facing surface that faces the sprocket in a radial direction of the sprocket; and when the chainsaw is viewed from a lateral side, a straight line passing through a center position of the saw chain at a location where the saw chain separates from the guide bar below the guide bar and through the center position of the saw chain at a location where the saw chain engages the sprocket below the sprocket is defined as a first reference line, a position at which the first reference line intersects the facing surface is defined as a first reference position, and an inclination angle of the facing surface with respect to the front-rear direction at the first reference position may be 90 degrees or more. Here, the chain-oil-free type chainsaw refers to a chainsaw that can conduct cutting operations without lubricating oil applied between the saw chain and the guide bar, and the lubricating oil may be applied to other mechanical components such as bearings.

Cutting debris generated by a cutting operation by the chainsaw moves with the saw chain from front to rear below the guide bar. After this, when the saw chain separates from the guide bar and engages the sprocket, the cutting debris will fly rearward along a trajectory that is substantially aligned with the first reference line. The cutting debris flying rearward collides with the facing surface near the first reference position. If the cutting debris that hit the facing surface bounces upward, the cutting debris may travel with the saw chain to the upper side of the chain passage, and may obstruct the chain passage. According to the above configuration, because the inclination angle of the facing surface with respect to the front-rear direction at the first reference position is 90 degrees or more, the cutting debris that hit the facing surface can be suppressed from bouncing upward. This can suppress the cutting debris from advancing to the upper side of the chain passage and clogging the chain passage.

### BRIEF DESCRIPTION OF DRAWINGS

FIG. 1 is a perspective view of a chainsaw 2 according to an embodiment, as viewed from a front left upper side.

FIG. 2 is a perspective view of a portion of a saw chain 6 according to the embodiment.

FIG. 3 is a perspective view of the chainsaw 2 according to the embodiment, viewed from a rear right upper side.

FIG. 4 is a perspective view of a state in which a sprocket cover 18 is removed from the chainsaw 2 according to the embodiment, as viewed from a rear left upper side.

FIG. 5 is a cross-sectional view of the chainsaw 2 according to the embodiment, as viewed from the left side.

FIG. 6 is a perspective view of an electric motor 64, a motor shaft 80, a cooling fan 82, a reduction drive 72, a drive shaft 84, a sprocket 26, a guide bar 4, and a saw chain 6 of the chainsaw 2 according to the embodiment, as viewed from a front right upper side.

FIG. 7 is a cross-sectional view of the sprocket 26 and its surroundings of the chainsaw 2 according to the embodiment, as viewed from the left side.

FIG. 8 is a perspective view of the sprocket cover 18 according to the embodiment, as viewed from the rear left upper side.

FIG. 9 is a perspective view of the sprocket cover 18 according to the embodiment, as viewed from the front right upper side.

FIG. 10 is a schematic diagram showing a relationship between a facing surface 18a according to the embodiment and inclination angles θ, φ, and ψ.

### DETAILED DESCRIPTION

In one aspect of the present teachings, when the chainsaw is viewed from the lateral side, the inclination angle of the facing surface with respect to the first reference line at the first reference position may be 90 degrees or more.

According to the above configuration, it is possible to more effectively suppress cutting debris that hit the facing surface from bouncing back to the upper side.

In one aspect of the present teachings, when the chainsaw is viewed from the lateral side, the inclination angle of the facing surface with respect to the front-rear direction at the first reference position may be 120 degrees or less.

If the inclination angle of the facing surface with respect to the front-rear direction at the first reference position exceeds 120 degrees, the size of the housing and/or sprocket cover increases in the front-rear direction, and the size of the chainsaw in the front-rear direction increases. According to the above configuration, the size of the housing and/or sprocket cover can be reduced in the front-rear direction, and the size of the chainsaw in the front-rear direction can be reduced.

In one aspect of the present teachings, when the chainsaw is viewed from the lateral side, a straight line that passes through the center position of the saw chain at a lowest end of the guide bar and extends in the front-rear direction is defined as a second reference line, a position at which the second reference line intersects the facing surface is defined as a second reference position, and the second reference position may be located in a range from directly below the first reference position to rearward of the first reference position.

The cutting debris that flies rearward when the saw chain separates from the guide bar and engages the sprocket hits not only the facing surface at the first reference position but also hits a certain area of the facing surface below the first reference position, because that cutting debris moves under the influence of gravity. According to the above configuration, the facing surface in a certain area where the cutting debris is easy to hit can be angled such that the cutting debris is difficult to bounce back to the upper side of the chain passage.

In one aspect of the present teachings, when the chainsaw is viewed from the lateral side, between the first reference position and the second reference position, the facing surface may not have a shape that protrudes toward the chain passage beyond a straight line connecting the first reference position and the second reference position.

According to the above configuration, the cutting debris that hit the facing surface can be easily discharged downward.

In one aspect of the present teachings, one of the housing and the sprocket cover may comprise a discharge port that is disposed below the sprocket and configured to discharge cutting debris from the chain passage, and a rear end of the discharge port may be located in a range from directly below the first reference position to rearward of the first reference position.

According to the above configuration, cutting debris that hit the facing surface can be more easily discharged through the discharge port.

In one aspect of the present teachings, the discharge port may have a shape in which a width in the left-right direction increases downward.

According to the above configuration, ease of discharging cutting debris from the discharge port can be improved.

In one aspect of the present teachings, a number of teeth of the sprocket may be nine or more.

At a location where the saw chain separates from the guide bar and engages the sprocket, a large tension is exerted on the saw chain. If the number of teeth on the sprocket is small, a bending angle of the saw chain at the location where the saw chain separates from the guide bar and engages the sprocket, that is, where the saw chain is under greater tension, becomes large, and a connection between a drive link and connecting pins of the saw chain becomes prone to wear. According to the above configuration, since the number of teeth of the sprocket is nine or more, the bending angle of the saw chain can be reduced at the location where the saw chain separates from the guide bar and engages the sprocket, that is, at the location where the saw chain is under greater tension. As a result of this, wear of the connection between the drive link and the connecting pins of the saw chain can be suppressed.

In one aspect of the present teachings, the guide bar may be a guide bar which does not include a sprocket at a tip portion of the guide bar.

In a guide bar with a sprocket incorporated in the tip portion of the guide bar, when the connection between the drive link and the connecting pins of the saw chain wears out and the saw chain is thereby stretched, the sprocket at the tip portion of the guide bar and the drive link do not mesh well, as a result of which abnormal noise is likely to occur. According to the above configuration, the use of the guide bar which does not include a sprocket at the tip portion of the guide bar can suppress generation of abnormal noise even if the connection between the drive link and the connecting pins of the saw chain wears out and the saw chain is thereby stretched.

In one aspect of the present teachings, a traveling speed of the saw chain may be 9 m/s or less.

The faster the saw chain travels, the faster the wear of the saw chain progresses. According to the above configuration, the wear of the saw chain can be suppressed by setting the traveling speed of the saw chain to 9 m/s or less.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved chainsaws.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

### Embodiment

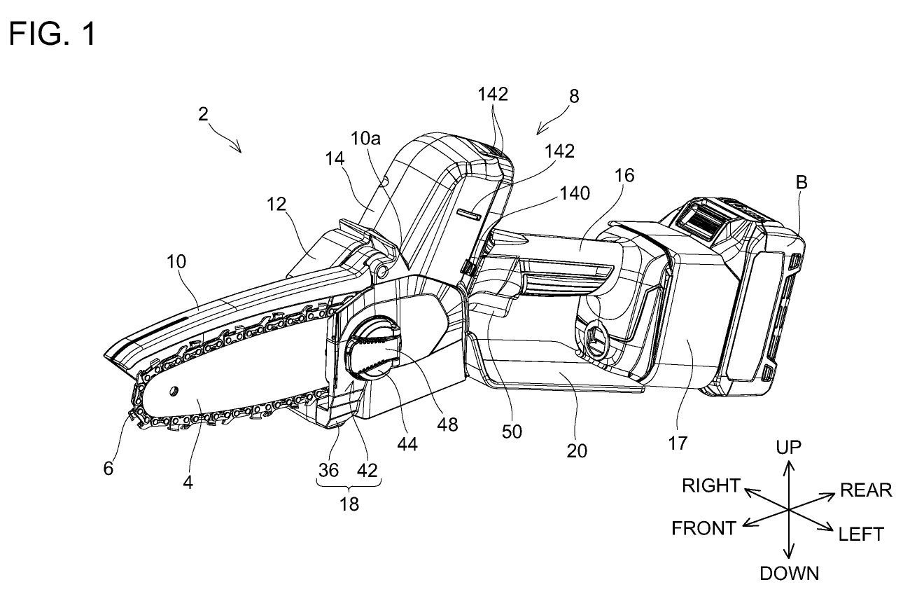

As shown in FIG. 1, a chainsaw 2 in this embodiment is a so-called pruning saw, which is mainly used for cutting wood, tree branches, etc., with a user holding it in one hand.

The chainsaw 2 comprises a guide bar 4, a saw chain 6, a housing 8, a chain cover 10, a sprocket cover 18, and a battery pack B. The chainsaw 2 causes the saw chain 6 to travel along the perimeter of the guide bar 4 by electric power supplied from the battery pack B. For example, the speed at which the saw chain 6 is caused to travel along the perimeter of the guide bar 4 is 9 m/s or less. The chainsaw 2 is a chain-oil-free type chainsaw 2, which can conduct cutting operations without lubricating oil applied between the guide bar 4 and the saw chain 6.

The guide bar 4 is an elongated plate-shaped member attached to the housing 8 such that the guide bar 4 protrudes frontward from the housing 8. The guide bar 4 has an up-down directional bulge around the center of the longitudinal direction of the guide bar 4 to improve cutting performance. The guide bar 4 is, for example, a guide bar 4 which does not include the sprocket in the tip portion. The longitudinal dimension of the guide bar 4 is within the range from 50 mm to 256 mm, and for example is 150 mm. The short dimension of the guide bar 4 is within the range from 30 mm to 70 mm, and for example is 50 mm. In this embodiment, the longitudinal direction of the guide bar 4 is a front-rear direction, a direction from the base end to the tip of the guide bar 4 is a frontward direction, and the reverse direction of the frontward direction is a rearward direction. A direction perpendicular to the front-rear direction and the short direction of the guide bar 4 is the up-down direction, and a direction in which the saw chain 6 travels on the tip side of the guide bar 4 is a downward direction, and the reverse direction of the downward direction is an upward direction. A direction perpendicular to the front-rear and up-down directions and which is the thickness direction of the guide bar 4 is a left-right direction. A straight line passing through the center position of the guide bar 4 in the up-down and left-right directions and extending in the front-rear direction will also be referred to as a center axis of the guide bar 4.

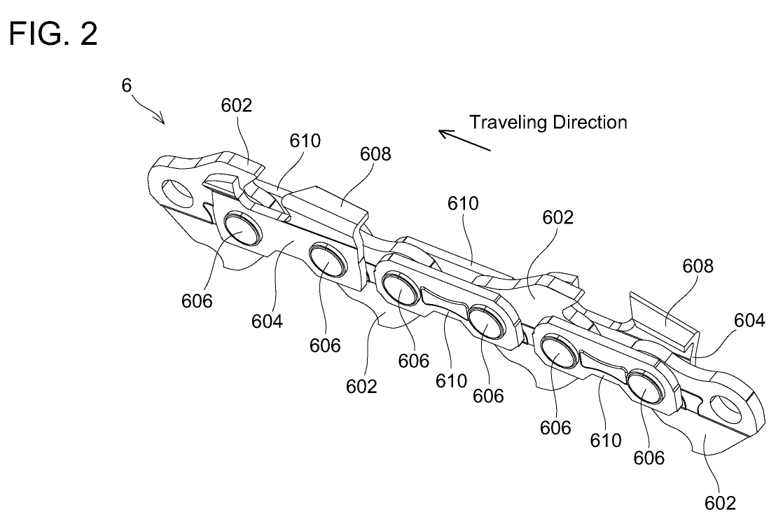

As shown in FIG. 2, the saw chain 6 comprises a plurality of drive links 602 that are aligned along the traveling direction of the saw chain 6 and are to be received in grooves (not shown) at the perimeter of the guide bar 4, tie straps 610 that are disposed on both left and right sides of the plurality of drive links 602, a plurality of side links 604 disposed on both left and right sides and comprising cutting portions 608, and a plurality of connecting pins 606 that connects the plurality of drive links 602 with the plurality of side links 604 or the plurality of tie straps 610 respectively to each other. In this specification, the center of the saw chain 6 refers to the centers of the connecting pins 606.

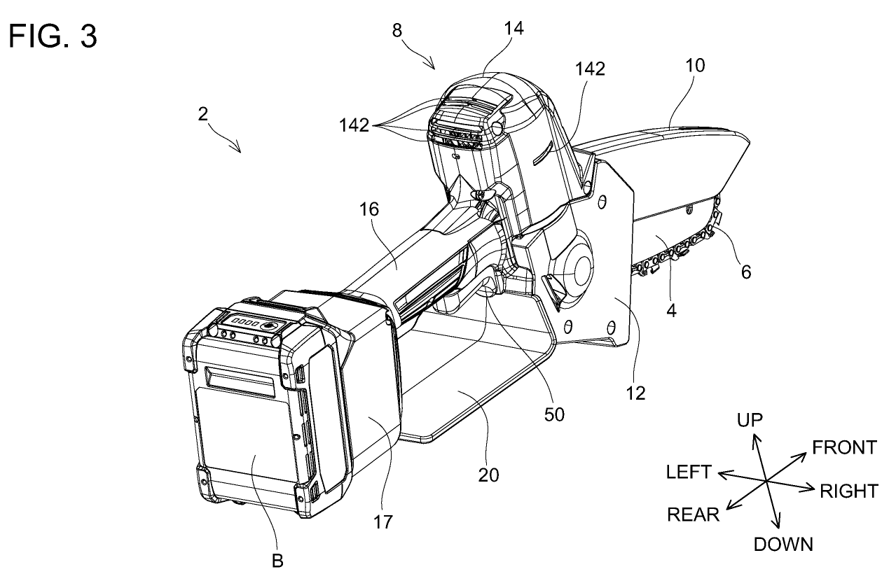

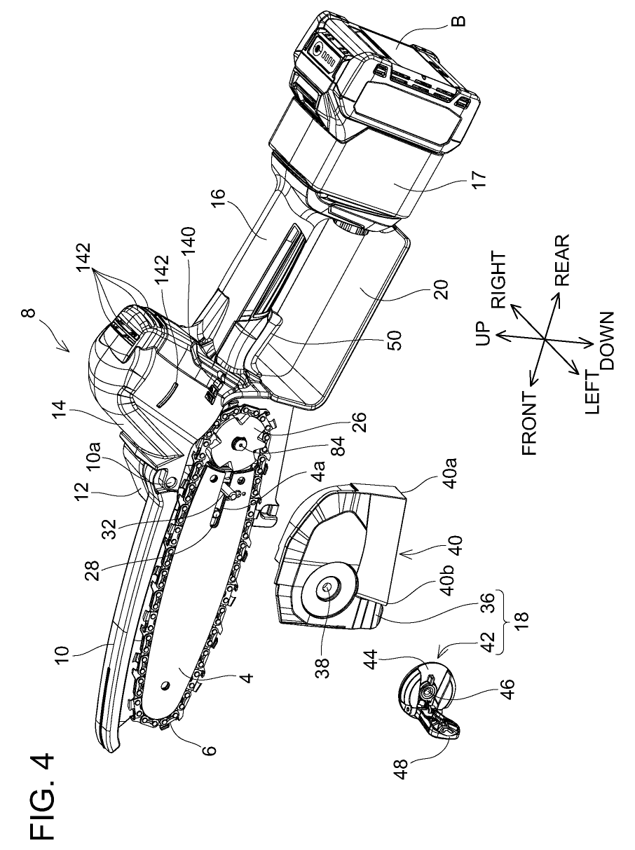

As shown in FIG. 3, the housing 8 comprises a gear housing 12, a motor housing 14, a grip 16, a battery pack attaching portion 17, and a hand guard 20. As shown in FIG. 4, the gear housing 12 holds the base end of the guide bar 4 along with the sprocket cover 18. The motor housing 14 extends to a rear upper direction from an upper part of the rear side of the gear housing 12. The grip 16 extends rearward and downward from a lower part of the rear side of the motor housing 14. The grip 16 has a substantially cylindrical cross-sectional shape. The battery pack attaching portion 17 is arranged at the rear end of the grip 16. The hand guard 20 has a wide, flat plate shape, with its front end connected to the lower end of the rear part of the gear housing 12 and its rear end connected to the lower end of the front part of the battery pack attaching portion 17.

As shown in FIG. 4, a trigger lever 50 for the user to drive and operate the saw chain 6 is disposed on the lower surface near the front end of the grip 16. The user can pull the trigger lever 50 toward the grip 16. A trigger switch (not shown) configured to detect the user's pulling of the trigger lever 50 is arranged inside the grip 16. The trigger switch is electrically connected to a control unit 60 described below.

As shown in FIG. 3, the hand guard 20 is a protector for protecting a user's hand by covering the user's hand grasping the grip 16 from below. If the saw chain 6 is broken during the execution of cutting work by the user (while the saw chain 6 is in operation), the broken saw chain 6 may fly out of the guide bar 4 while maintaining its running momentum. In such a case, the hand guard 20 can restrain the saw chain 6 that has jumped out of the guide bar 4 from coming into contact with the hand of the user holding the grip 16.

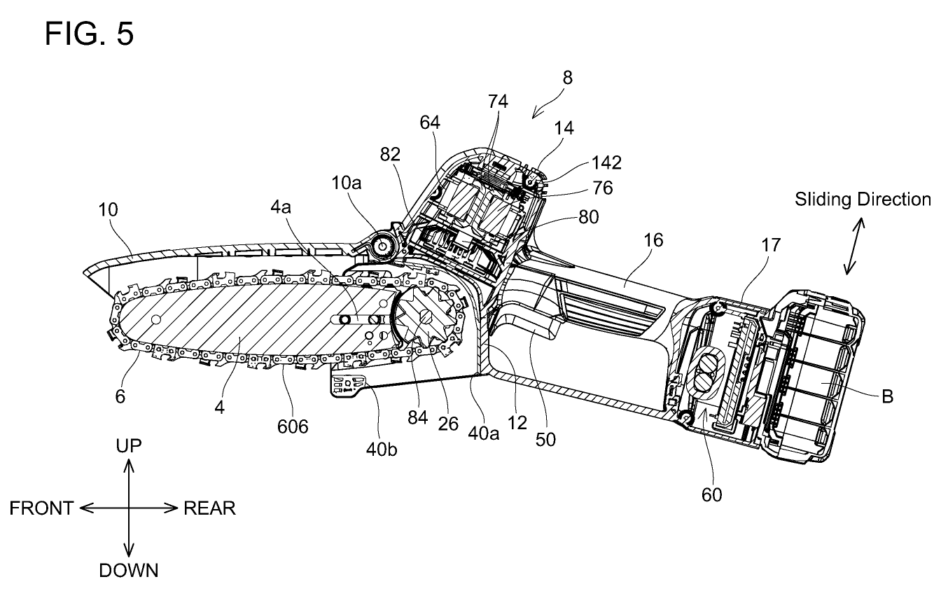

The battery pack B can be attached to and removed from the battery pack attaching portion 17. The battery pack B contains rechargeable secondary battery or batteries, such as lithium-ion battery, for example. The output voltage of the battery pack B is, for example, 10 V. The battery capacity of the battery pack B is, for example, 1.5 Ah. As shown in FIG. 5, the battery pack B can be attached to the battery pack attaching portion 17 by sliding it from a rear upper direction to a front lower direction, and can be removed from the battery pack attaching portion 17 by sliding it from the front lower direction to the rear upper direction. The control unit 60 is housed inside the battery pack attaching portion 17. The battery pack B is electrically connected to the control unit 60 when attached to the battery pack attaching portion 17.

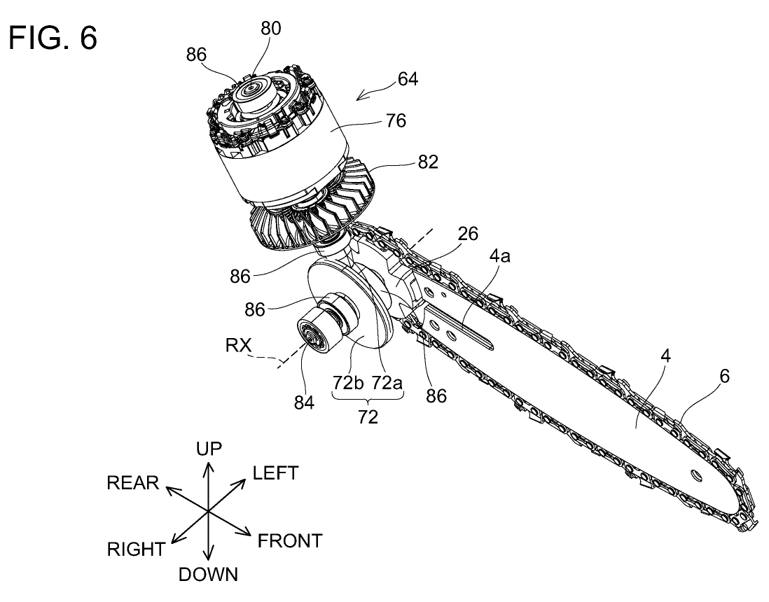

An electric motor 64 and a cooling fan 82 are housed inside the motor housing 14. The electric motor 64 is, for example, an inner rotor type DC brushless motor. The electric motor 64 comprises a stator 76 with a coil 74 wound thereabout and a rotor (not shown) that is disposed inside the stator 76 and has permanent magnets. A motor shaft 80 is fixed to the rotor. The motor shaft 80 is disposed along a plane extending in the front-rear and up-down directions. The motor shaft 80 is disposed to tilt rearward from front as it extends from below to above with respect to the up-down direction. The motor shaft 80 is rotatably supported by the motor housing 14 via a plurality of bearings 86 (see FIG. 6). Even when the chainsaw 2 is a chain-oil-free chainsaw 2, the bearings 86 may be filled with lubricating oil.

The cooling fan 82 is fixed to the motor shaft 80 at a position frontward of and below the stator 76 and the rotor of the electric motor 64. The cooling fan 82 rotates as the motor shaft 80 rotates. As the cooling fan 82 rotates, an air flow is formed along the motor shaft 80 from the rear upper direction to the front lower direction. At this time, air is suctioned into the interior from exterior of the motor housing 14 through air intake ports 142 defined at a rear part of the upper surface and an upper part of the rear surface of the motor housing 14, and air is discharged from the interior to the exterior of the motor housing 14 through an exhaust port 140 (see FIG. 1) defined at a lower part of the left surface of the motor housing 14. This air flow can cool the electric motor 64.

A reduction drive 72 (see FIG. 6) is housed inside the gear housing 12. As shown in FIG. 6, the reduction drive 72 comprises a first bevel gear 72a and a second bevel gear 72b. The first bevel gear 72a is fixed to the motor shaft 80 at a position frontward of and below the cooling fan 82. The second bevel gear 72b is fixed to the drive shaft 84. The drive shaft 84 is disposed along the left-right direction. The drive shaft 84 is rotatably supported by the gear housing 12 (see FIG. 5) via the plurality of bearings 86. The reduction drive 72 transmits the rotation of the motor shaft 80 to the drive shaft 84 by the first bevel gear 72a and the second bevel gear 72b meshing with each other. As a result, the drive shaft 84 rotates about a rotation axis RX.

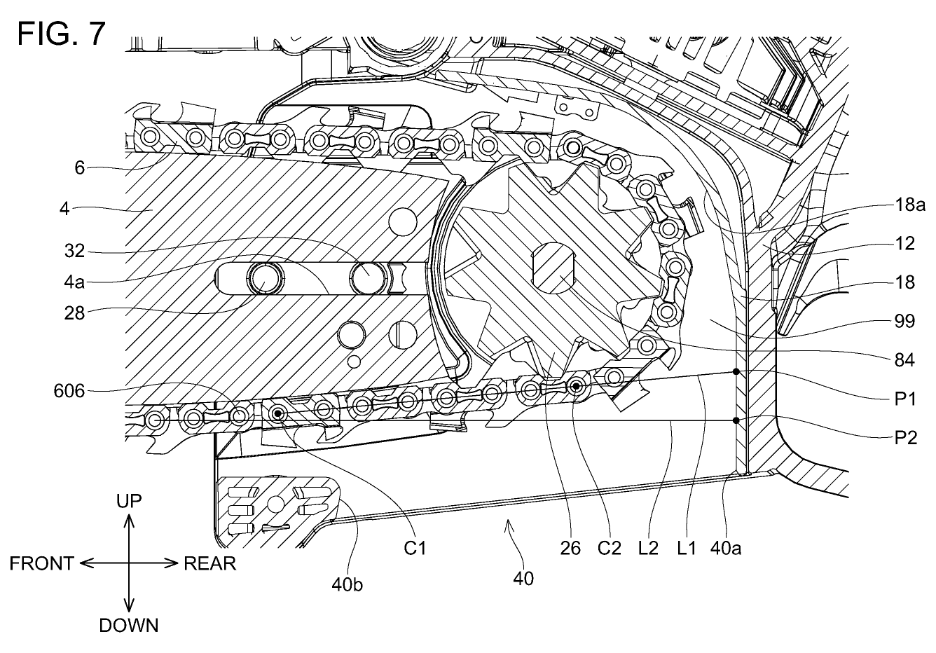

As shown in FIG. 4, the left end of the drive shaft 84 protrudes leftward from the left surface of the gear housing 12. The sprocket 26 is fixed to the left end of the drive shaft 84 outside the gear housing 12. As shown in FIG. 7, in this embodiment, the number of teeth on the sprocket 26 is, for example, nine. As shown in FIG. 6, the saw chain 6 is looped around the guide bar 4 and the sprocket 26. When the electric motor 64 is driven, the rotational motion of the motor shaft 80 is transmitted to the drive shaft 84 via the reduction drive 72, causing the sprocket 26 to rotate about the rotation axis RX, and the saw chain 6 travels on the perimeter of the guide bar 4.

As shown in FIG. 5, the control unit 60 comprises an inverter circuit with a plurality of switching elements and a control board (not shown) on which a control circuit that controls operations of the respective switching elements is mounted. The control unit 60 is configured to control operation of the electric motor 64 by adjusting electric power supplied from the battery pack B to the electric motor 64.

As shown in FIG. 3, the chain cover 10 is disposed so as to cover the upper half of the upper part and right part of the guide bar 4. As shown in FIG. 4, the chain cover 10 is attached to the gear housing 12 such that the chain cover 10 is pivotable about a pivot axis 10a. The chain cover 10 is configured to pivot between a normal position (see FIG. 4) where the tip has pivoted downward, and a retracted position (not shown) where the tip has pivoted upward. The chain cover 10 is biased by a torsion spring (not shown) from the retracted position toward the normal position.

The guide bar 4 comprises a notch 4a extending frontward from the rear end of the guide bar 4. In the notch 4a, a pin 28 and a bolt 32 that protrude leftward from the left surface of the gear housing 12 are disposed. The left end of the pin 28 is located to the right of the left surface of the guide bar 4. The left end of the bolt 32 protrudes leftward more than the left surface of the guide bar 4.

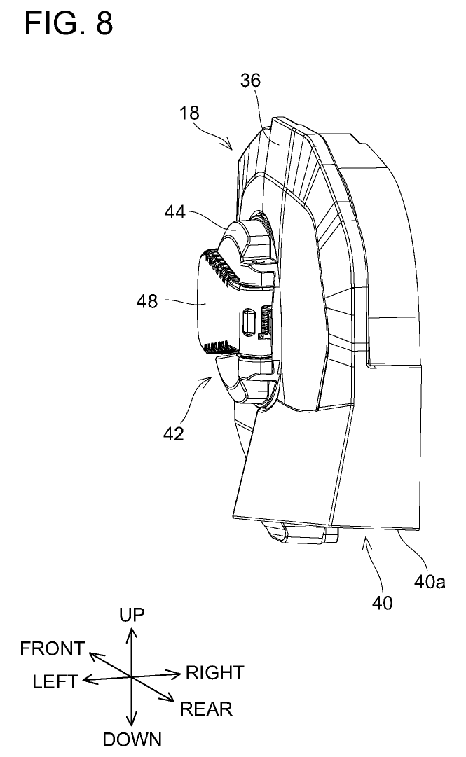

The sprocket cover 18 comprises a sprocket cover body 36 and an engagement member 42. The sprocket cover body 36 comprises a through hole 38 through which the bolt 32 can pass and a discharge port 40 that opens downward. As shown in FIG. 8, the discharge port 40 has a shape in which a width in the left-right direction increases as it extends from above to below. As shown in FIG. 4, the engagement member 42 comprises an engagement member body 44, a nut 46 fixed to the engagement member body 44 and to which the bolt 32 is screwed, and a pawl 48 for the user to rotate the engagement member body 44.

The sprocket cover 18 can be attached to the gear housing 12 by screwing the nut 46 of the engagement member 42 to the bolt 32 that passes through the through hole 38 in the sprocket cover body 36. With the nut 46 tightened relative to the bolt 32, the guide bar 4 is secured by being sandwiched between the gear housing 12 and the sprocket cover 18. With the nut 46 loosened relative to the bolt 32, the guide bar 4 can be slid in the front-rear direction relative to the gear housing 12, and the distance between the guide bar 4 and the sprocket 26 can be changed to adjust the tension of the saw chain 6. The user can tighten or loosen the nut 46 relative to the bolt 32 without using any special tool by rotating the pawl 48, which is raised to the left relative to the engagement member body 44, about the axis of the bolt 32. As shown in FIG. 1, the pawl 48 in its normal state is retained by a torsion spring (not shown) in a lying position along the engagement member body 44.

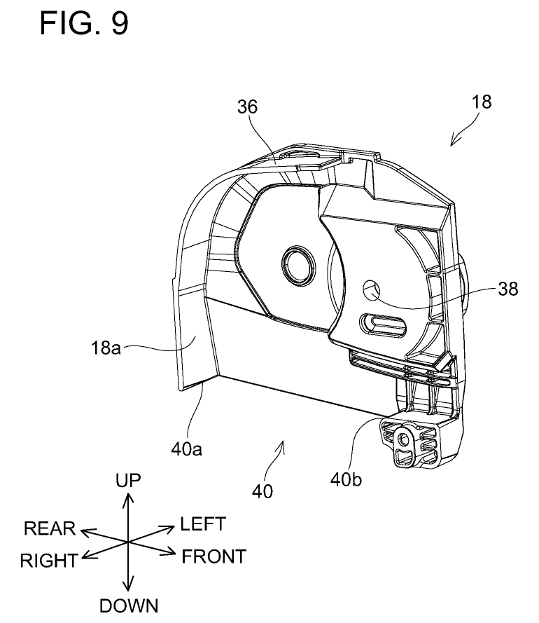

As shown in FIG. 7, a chain passage 99 through which the saw chain 6 passes is formed between the sprocket 26, the gear housing 12, and the sprocket cover 18. As shown in FIG. 9, the sprocket cover 18 comprises a facing surface 18a. As shown in FIG. 7, in the chain passage 99, the facing surface 18a faces the saw chain 6 in the radial direction of the sprocket 26. The facing surface 18a may be arranged in the gear housing 12 instead of the sprocket cover 18.

As the sprocket 26 rotates, the saw chain 6 moves around the guide bar 4 and the sprocket 26. Specifically, focusing on one connecting pin 606 of the saw chain 6 below the guide bar 4, the connecting pin 606 moves from below the guide bar 4 to below the sprocket 26. The connecting pin 606 then moves from below the sprocket 26 to move on the rear side of the sprocket 26 to above the sprocket 26. Further thereafter, the connecting pin 606 moves from above the sprocket 26 to above the guide bar 4, and from above the guide bar 4 to move on the front side of the guide bar 4 to below the guide bar 4. The saw chain 6 (connecting pin 606) repeats the above series of rotation across the guide bar 4 and the sprocket 26 as the sprocket 26 rotates.

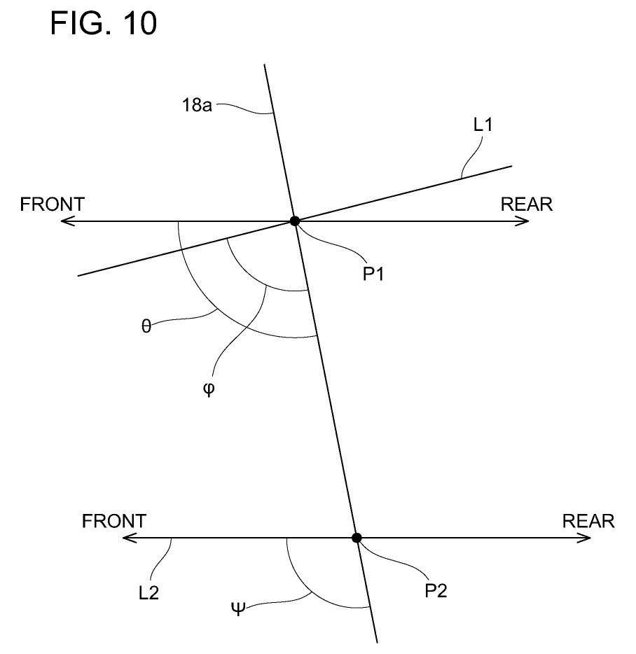

The saw chain 6 below the guide bar 4 separates from the guide bar 4 at a location C1. In particular, the location C1 where the saw chain 6 separates from the guide bar 4 can be defined as a location at which an angle formed between the tangential direction of the guide bar 4 and the traveling direction of the saw chain 6 is 0.5 degrees or more. After the saw chain 6 has separated from the guide bar 4, the saw chain 6 engages the sprocket 26 at a location C2. The location C2 where the saw chain 6 engages the sprocket 26 can be defined as a location at which the angle between the tangential direction of the rotation of the sprocket 26 and the traveling direction of the saw chain 6 is within 5 degrees. When the chainsaw 2 is viewed from the left, a straight line passing through the center position of the saw chain 6 (i.e., center position of the connecting pins 606) at the location C1 where the saw chain 6 separates from the guide bar 4 below the guide bar 4 and through the center position of the saw chain 6 (i.e., center position of the connecting pins 606) at the location C2 where the saw chain 6 engages the sprocket 26 below the sprocket 26 is defined as a first reference line L1. A position at which the first reference line L1 intersects the facing surface 18a is defined as a first reference position P1. In this case, an inclination angle θ (see FIG. 10) of the facing surface 18a with respect to the front-rear direction at the first reference position P1 is within the range from 90 degrees to 120 degrees, and is for example, 90 degrees. An inclination angle φ (see FIG. 10) of the facing surface 18a at the first reference position P1 with respect to the first reference line L1 is, for example, within the range from 70 degrees to 120 degrees, and is for example 85 degrees.

As shown in FIG. 7, when the chainsaw 2 is viewed from the left, a straight line that passes through the center position of the saw chain 6 (i.e., the center position of the connecting pins 606) at the lowest end of the guide bar 4 and extends in the front-rear direction is defined as a second reference line L2. A position at which the second reference line L2 intersects the facing surface 18a is defined as a second reference position P2. In this case, an inclination angle ψ (see FIG. 10) of the facing surface 18a with respect to the front-rear direction at the second reference position P2 is within the range from 90 degrees to 120 degrees, and is for example 90 degrees.

As shown in FIG. 7, the second reference position P2 is located in a range from directly below to rearward of the first reference position P1. Between the first reference position P1 and the second reference position P2, the facing surface 18a does not have a shape that protrudes toward the chain passage 99 beyond a straight line connecting the first reference position P1 and the second reference position P2. Furthermore, the rear end 40a of the discharge port 40 provided by the sprocket cover 18 is located in a range from directly below the first reference position P1 to rearward of the first reference position P1. The rear end 40a of the discharge port 40 is located rearward of the rear end of the sprocket 26, and a front end 40b of the discharge port 40 is located frontward of the front end of the sprocket 26.

### Variations

The above embodiment describes a configuration in which the chainsaw 2 is a pruning saw that can be grasped by a user with one hand. In another embodiment, the chainsaw 2 may be a top handle chainsaw or a rear handle chainsaw that the user can grasp and use with both hands.

The above embodiment describes a configuration in which the chainsaw 2 comprises the battery pack B that can be attached and removed. In another embodiment, the chainsaw 2 may be powered from an external power source via a cable instead of comprising the battery pack B.

The above embodiment describes a configuration in which the speed at which the saw chain 6 is caused to travel along the perimeter of the guide bar 4 is 9 m/s or less. In another embodiment, the speed at which the saw chain 6 is caused to travel along the perimeter of the guide bar 4 may be faster than 9 m/s.

The above embodiment describes a configuration in which the guide bar 4 is a guide bar 4 that does not include the sprocket in the tip portion. In another embodiment, the guide bar 4 may be a guide bar 4 that includes a sprocket in the tip portion.

The above embodiment describes a configuration in which the electric motor 64 is an inner rotor type DC brushless motor. In another embodiment, the electric motor 64 may be an outer rotor type DC brushless motor. Alternatively, the electric motor 64 may be a brushed motor or any other type of electric motor.

The above embodiment describes a configuration in which the number of teeth on the sprocket 26 is nine. In another embodiment, the number of teeth of the sprocket 26 may be 10 or more or 8 or less.

The above embodiment describes a configuration in which the inclination angle θ (see FIG. 10) of the facing surface 18a with respect to the front-rear direction at the first reference position P1 is 120 degrees or less. In another embodiment, the inclination angle θ may be greater than 120 degrees.

The above embodiment describes a configuration in which the inclination angle φ (see FIG. 10) of the facing surface 18a with respect to the first reference line L1 at the first reference position P1 is 90 degrees or more. In another embodiment, the inclination angle φ may be less than 90 degrees.

The above embodiment describes a configuration in which the second reference position P2 is located in the range from directly below to rearward of the first reference position P1. In another embodiment, the second reference position P2 may be located in a range from directly below the first reference position P1 to frontward of the first reference position P1.

The above embodiment describes a configuration in which the facing surface 18a does not have a shape that protrudes toward the chain passage 99 beyond the straight line connecting the first reference position P1 and the second reference position P2. In another embodiment, the facing surface 18a may have a shape that protrudes toward the chain passage 99 beyond the straight line connecting the first reference position P1 and the second reference position P2.

The above embodiment describes a configuration in which the rear end 40a of the discharge port 40 is located in the range from directly below the first reference position P1 to rearward of the first reference position P1. In another embodiment, the rear end 40a of the discharge port 40 may be located in a range from directly below the first reference position P1 to frontward of the first reference position P1.

The above embodiment describes a configuration in which the discharge port 40 has a shape in which the width in the left-right direction increases as it extends from above to below. In another embodiment, the discharge port 40 may have a shape in which the width in the left-right direction is constant, or may have a shape in which the width in the left-right direction decreases as it extends from above to below.

### Features of Embodiment

As described above, in one or more embodiments, the chain-oil-free type chainsaw 2 comprises: the guide bar 4 disposed such that the center axis thereof extends along the front-rear direction; the sprocket 26 disposed rearward of the guide bar 4 such that a rotation axis thereof extends along the left-right direction; the saw chain 6 looped around the guide bar 4 and the sprocket 26; the electric motor 64 configured to rotate the sprocket 26 about the rotation axis; the housing 8 that accommodates the electric motor 64; and the sprocket cover 18 that covers the sprocket 26. The saw chain 6 travels such that, along with rotation of the sprocket 26, the saw chain 6 moves from below the guide bar 4 to below the sprocket 26, then moves from below the sprocket 26 to move on the rear side of the sprocket 26 to above the sprocket 26, then moves from above the sprocket 26 to above the guide bar 4, and then moves from above the guide bar 4 to move on the front side of the guide bar 4 to below the guide bar 4. The chain passage 99 through which the saw chain 6 passes is formed by the sprocket 26, the housing 8, and the sprocket cover 18, in the chain passage 99, at least one of the housing 8 and the sprocket cover 18 has the facing surface 18a that faces the sprocket 26 in the radial direction of the sprocket 26. When the chainsaw 2 is viewed from the lateral side, a straight line passing through the center position of the saw chain 6 (centers of the connecting pins 606) at the location C1 where the saw chain 6 separates from the guide bar 4 below the guide bar 4 and through the center position of the saw chain 6 (centers of the connecting pins 606) at the location C2 where the saw chain 6 engages the sprocket 26 below the sprocket 26 is defined as the first reference line L1, a position at which the first reference line L1 intersects the facing surface 18a is defined as the first reference position P1, and the inclination angle θ of the facing surface 18a with respect to the front-rear direction at the first reference position P1 is 90 degrees or more.

Cutting debris generated by a cutting operation by the chainsaw 2 moves with the saw chain 6 from front to rear below the guide bar 4. After this, when the saw chain 6 separates from the guide bar 4 and engages the sprocket 26, the cutting debris will fly rearward along a trajectory that is substantially aligned with the first reference line L1. The cutting debris flying rearward collides with the facing surface 18a near the first reference position P1. If the cutting debris that hit the facing surface 18a bounces upward, the cutting debris may travel with the saw chain 6 to the upper side of the chain passage 99, and may obstruct the chain passage 99. According to the above configuration, because the inclination angle θ of the facing surface 18a with respect to the front-rear direction at the first reference position P1 is 90 degrees or more, the cutting debris that hit the facing surface 18a can be suppressed from bouncing upward. This can suppress the cutting debris from advancing to the upper side of the chain passage 99 and clogging the chain passage 99.

In one or more embodiments, when the chainsaw 2 is viewed from the lateral side, the inclination angle φ of the facing surface 18a with respect to the first reference line L1 at the first reference position P1 is 90 degrees or more.

According to the above configuration, it is possible to more effectively suppress cutting debris that hit the facing surface 18a from bouncing back to the upper side.

In one or more embodiments, when the chainsaw 2 is viewed from the lateral side, the inclination angle θ of the facing surface 18a with respect to the front-rear direction at the first reference position P1 is 120 degrees or less.

If the inclination angle θ of the facing surface 18a with respect to the front-rear direction at the first reference position P1 exceeds 120 degrees, the size of the housing 8 and/or sprocket cover 18 increases in the front-rear direction, and the size of the chainsaw 2 in the front-rear direction increases. According to the above configuration, the size of the housing 8 and/or sprocket cover 18 can be reduced in the front-rear direction, and the size of the chainsaw 2 in the front-rear direction can be reduced.

In one or more embodiments, when the chainsaw 2 is viewed from the lateral side, a straight line that passes through the center position of the saw chain 6 (centers of the connecting pins 606) at the lowest end of the guide bar 4 and extends in the front-rear direction is defined as the second reference line L2, a position at which the second reference line L2 intersects the facing surface 18a is defined as the second reference position P2, and the second reference position P2 is located in the range from directly below the first reference position P1 to rearward of the first reference position P1.

The cutting debris that flies rearward when the saw chain 6 separates from the guide bar 4 and engages the sprocket 26 hits not only the facing surface 18a at the first reference position P1 but also hits a certain area of the facing surface 18a below the first reference position P1, because that cutting debris moves under the influence of gravity. According to the above configuration, the facing surface 18a in a certain area where the cutting debris is easy to hit can be angled such that the cutting debris is difficult to bounce back to the upper side of the chain passage 99.

In one or more embodiments, when the chainsaw 2 is viewed from the lateral side, between the first reference position P1 and the second reference position P2, the facing surface 18a does not have a shape that protrudes toward the chain passage 99 beyond a straight line connecting the first reference position P1 and the second reference position P2.

According to the above configuration, the cutting debris that hit the facing surface 18a can be easily discharged downward.

In one or more embodiments, one of the housing 8 and the sprocket cover 18 comprises a discharge port 40 that is disposed below the sprocket 26 and configured to discharge cutting debris from the chain passage 99, and a rear end of the discharge port 40 is located in a range from directly below the first reference position P1 to rearward of the first reference position P1.

According to the above configuration, cutting debris that hit the facing surface 18a can be more easily discharged through the discharge port 40.

In one or more embodiments, the discharge port 40 has a shape in which the width in the left-right direction increases downward.

According to the above configuration, ease of discharging cutting debris from the discharge port 40 can be improved.

In one or more embodiments, the number of teeth of the sprocket 26 is nine or more.

At a location where the saw chain 6 separates from the guide bar 4 and engages the sprocket 26, a large tension is exerted on the saw chain 6. If the number of teeth on the sprocket 26 is small, the bending angle of the saw chain 6 at the location where the saw chain 6 separates from the guide bar 4 and engages the sprocket 26, that is, where the saw chain 6 is under greater tension, becomes large, and a connection between the drive links 602 and connecting pins 606 of the saw chain 6 becomes prone to wear. According to the above configuration, since the number of teeth of the sprocket 26 is nine or more, the bending angle of the saw chain 6 can be reduced at the location where the saw chain 6 separates from the guide bar 4 and engages the sprocket 26, that is, at the location where the saw chain 6 is under greater tension. As a result of this, wear of the connection between the drive links 602 and the connecting pins 606 of the saw chain 6 can be suppressed.

In one or more embodiments, the guide bar 4 is a guide bar 4 which does not include a sprocket at a tip portion of the guide bar 4.

In a guide bar with a sprocket incorporated in the tip portion of the guide bar, when the connection between the drive links 602 and the connecting pins 606 of the saw chain 6 wears out and the saw chain 6 is thereby stretched, the sprocket at the tip portion of the guide bar and the drive links 602 do not mesh well, as a result of which abnormal noise is likely to occur. According to the above configuration, the use of the guide bar 4 which does not include a sprocket at the tip portion of the guide bar 4 can suppress generation of abnormal noise even if the connection between the drive links 602 and the connecting pins 606 of the saw chain 6 wears out and the saw chain 6 is thereby stretched.

In one or more embodiments, the traveling speed of the saw chain 6 is 9 m/s or less.

The faster the saw chain 6 travels, the faster the wear of the saw chain 6 progresses. According to the above configuration, the wear of the saw chain 6 can be suppressed by setting the traveling speed of the saw chain 6 to 9 m/s or less.

What is claimed is:

1. A chain-oil-free type chainsaw comprising:
a guide bar disposed such that a center axis thereof extends along a front-rear direction;
a sprocket disposed rearward of the guide bar such that a rotation axis thereof extends along a left-right direction;
a saw chain looped around the guide bar and the sprocket;
an electric motor configured to rotate the sprocket about the rotation axis;
a housing that accommodates the electric motor; and
a sprocket cover that covers the sprocket,
wherein the saw chain travels such that, along with rotation of the sprocket, the saw chain moves from below the guide bar to below the sprocket, then moves from below the sprocket to move on a rear side of the sprocket to above the sprocket, then moves from above the sprocket to above the guide bar, and then moves from above the guide bar to move on a front side of the guide bar to below the guide bar,
a chain passage through which the saw chain passes is formed by the sprocket, the housing, and the sprocket cover,
in the chain passage, at least one of the housing and the sprocket cover has a facing surface that faces the sprocket in a radial direction of the sprocket; and
when the chainsaw is viewed from a lateral side, a straight line passing through a center position of the saw chain at a location where the saw chain separates from the guide bar below the guide bar and through the center position of the saw chain at a location where the saw chain engages the sprocket below the sprocket is defined as a first reference line, a position at which the first reference line intersects the facing surface is defined as a first reference position, and an inclination angle of the facing surface with respect to the front-rear direction at the first reference position is 90 degrees or more.

2. The chainsaw according to claim 1, wherein, when the chainsaw is viewed from the lateral side, the inclination angle of the facing surface with respect to the first reference line at the first reference position is 90 degrees or more.

3. The chainsaw according to claim 1, wherein, when the chainsaw is viewed from the lateral side, the inclination angle of the facing surface with respect to the front-rear direction at the first reference position is 120 degrees or less.

4. The chainsaw according to claim 1, wherein, when the chainsaw is viewed from the lateral side, a straight line that passes through the center position of the saw chain at a lowest end of the guide bar and extends in the front-rear direction is defined as a second reference line, a position at which the second reference line intersects the facing surface is defined as a second reference position, and the second reference position is located in a range from directly below the first reference position to rearward of the first reference position.

5. The chainsaw according to claim 4, wherein, when the chainsaw is viewed from the lateral side, between the first reference position and the second reference position, the facing surface does not have a shape that protrudes toward the chain passage beyond a straight line connecting the first reference position and the second reference position.

6. The chainsaw according to claim 1, wherein one of the housing and the sprocket cover comprises a discharge port that is disposed below the sprocket and configured to discharge cutting debris from the chain passage, and a rear end of the discharge port is located in a range from directly below the first reference position to rearward of the first reference position.

7. The chainsaw according to claim 6, wherein the discharge port has a shape in which a width in the left-right direction increases downward.

8. The chainsaw according to claim 1, wherein a number of teeth of the sprocket is nine or more.

9. The chainsaw according to claim 1, wherein the guide bar is a guide bar which does not include a sprocket at a tip portion of the guide bar.

10. The chainsaw according to claim 1, wherein a traveling speed of the saw chain is 9 m/s or less.

11. The chainsaw according to claim 2, wherein, when the chainsaw is viewed from the lateral side, the inclination angle of the facing surface with respect to the front-rear direction at the first reference position is 120 degrees or less; when the chainsaw is viewed from the lateral side, a straight line that passes through the center position of the saw chain at a lowest end of the guide bar and extends in the front-rear direction is defined as a second reference line, a position at which the second reference line intersects the facing surface is defined as a second reference position, and the second reference position is located in a range from directly below the first reference position to rearward of the first reference position; when the chainsaw is viewed from the lateral side, between the first reference position and the second reference position, the facing surface does not have a shape that protrudes toward the chain passage beyond a straight line connecting the first reference position and the second reference position; one of the housing and the sprocket cover comprises a discharge port that is disposed below the sprocket and configured to discharge cutting debris from the chain passage, and a rear end of the discharge port is located in a range from directly below the first reference position to rearward of the first reference position; the discharge port has a shape in which a width in the left-right direction increases downward; a number of teeth of the sprocket is nine or more; the guide bar is a guide bar which does not include a sprocket at a tip portion of the guide bar; and a traveling speed of the saw chain is 9 m/s or less.
